(19) United States
(12) Patent Application Publication
(10) Pub. No.: US 2013/0057435 A1
(43) Pub. Date: Mar. 7, 2013

(54) AUXILIARY AP TAG AND POSITIONING SYSTEM USING THE SAME

(71) Applicant: Bum Youl KIM, Anyang-si (KR)

(72) Inventor: Bum Youl KIM, Anyang-si (KR)

(73) Assignee: LSIS CO., LTD., Anyang-si (KR)

(21) Appl. No.: 13/604,430

(22) Filed: Sep. 5, 2012

(30) Foreign Application Priority Data
Sep. 5, 2011 (KR) 10-2011-0089813

(51) Int. Cl. G01S 5/02

(52) U.S. Cl. 342/450

(57) ABSTRACT

Provided is an auxiliary Access Point (AP) tag and a positioning system using the same, wherein the auxiliary AP tag simpler in structure than a conventional AP is arranged at the system to be provided with only a function of transmitting an identifier (e.g., a service set identifier), whereby position accuracy can be stably obtained and cost can be reduced.

Pursuant to 35 U.S.C. §119 (a), this application claims the benefit of earlier filing date and right of priority to Korean Patent Application No. 10-2011-0089813, filed on Sep. 5, 2011, the contents of which is hereby incorporated by reference in their entirety.

### BACKGROUND OF THE DISCLOSURE

1. Field of Endeavor

The present disclosure relates to an auxiliary Access Point (AP) tag, and more particularly to an auxiliary AP tag configured for use in a wireless LAN-based positioning system and a positioning system using the same.

2. Background

This section provides background information related to the present disclosure which is not necessarily prior art.

Generally, a wireless local area network (WLAN) links two or more devices using some wireless distribution method (typically spread-spectrum or OFDM radio), and usually providing a connection through an access point to the wider internet. This gives users the mobility to move around within a local coverage area and still be connected to the network. Most modern WLANs are based on IEEE 802.11 standards, marketed under the Wi-Fi brand name.

That is, a wireless LAN (or WLAN, for wireless local area network, sometimes referred to as LAWN, for local area wireless network) is one in which a mobile user can connect to a local area network (LAN) through a wireless (radio) connection. The IEEE 802.11 group of standards specifies the technologies for wireless LANs. 802.11 standards use the Ethernet protocol and CSMA/CA (carrier sense multiple access with collision avoidance) for path sharing and include an encryption method, the Wired Equivalent Privacy algorithm. A subscriber can be wirelessly connected to a network using a terminal mounted on a WLAN card at around a predetermined radius from a point where an AP is installed.

### SUMMARY OF THE DISCLOSURE

This Summary is provided to introduce a selection of concepts in a simplified form that are further described below in the Detailed Description. This Summary is not intended to identify key or essential features of the claimed subject matter; nor is it to be used for determining or limiting the scope of the claimed subject matter.

Accordingly, embodiments of the present disclosure may relate to an auxiliary AP (Access Point) tag and a positioning system using the same that may substantially obviate one or more of the above disadvantages due to limitations and disadvantages of related art, and it is therefore an object of the present disclosure to provide an auxiliary AP tag configured to maintain a positioning accuracy and simplify a system by arranging a plurality of auxiliary AP tags capable of transmitting only identifiers, and a positioning system using the auxiliary AP tag.

Technical problems to be solved by the present disclosure are not restricted to the above-mentioned, and any other technical problems not mentioned so far will be clearly appreciated from the following description by skilled in the art.

In one general aspect of the present disclosure, there is provided an auxiliary AP tag of a positioning system capable of tracking a position of a positioning tag attached to a position track subject, the auxiliary AP tag comprising: a transmission antenna; storage storing an identifier identifying the auxiliary AP tag; and a transmission unit transmitting the identifier through the transmission antenna.

Preferably, but not necessarily, the identifier includes an SSID (Service Set Identifier).

In another general aspect of the present disclosure, there is provided a positioning system tracking a positioning tag attached to a position track subject, the position system comprising: at least one or more APs transmitting information necessary for a position received from the positioning tag to a positioning server, and transmitting its identifier to the positioning tag; a plurality of auxiliary AP tags transmitting its identifier to the positioning tag; and the positioning server receiving information necessary for the position transmitted by the positioning tag and positioning the positioning tag.

Preferably, but not necessarily, the information necessary for positioning includes the identifier of the AP and the auxiliary AP tag received by the positioning tag and intensity of radio wave of a signal transmitted by the AP and the auxiliary AP tag.

Preferably, but not necessarily, the auxiliary AP tag transmits a beacon signal including the identifier.

Preferably, but not necessarily, the auxiliary AP tag periodically transmits the identifier at a predetermined period.

Preferably, but not necessarily, the auxiliary AP tag includes a transmission antenna; storage storing the identifier; and a transmission unit transmitting the identifier to the positioning tag through the transmission antenna.

Preferably, but not necessarily, the identifier is an SSID.

The auxiliary AP (Access Point) tag and a positioning system using the same according to the present disclosure has an advantageous effect in that an auxiliary AP tag simpler in structure than a conventional AP is arranged at the system to be provided with only function of transmitting an identifier (e.g., SSID), whereby position accuracy can be stably obtained and cost can be reduced.

### BRIEF DESCRIPTION OF THE DRAWINGS

In order to explain the principle of the present disclosure, some accompanying drawings related to its preferred embodiments are below reported for the purpose of illustration, exemplification and description, although they are not intended to be exhaustive. The drawing figures depict one or more exemplary embodiments in accord with the present concepts, by way of example only, not by way of limitations. In the figures, like reference numerals refer to the same or similar elements.

Thus, a wide variety of potential practical and useful embodiments will be more readily understood through the following detailed description of certain exemplary embodiments, with reference to the accompanying exemplary drawings in which:

FIG. 1 is a graph illustrating a measurement of RSSI (Received Signal Strength Indicator) of a signal received by a positioning tag when a height of an AP is 1.5 m and a height of the positioning tag is 1.2 m;

FIG. 2 is a structural view illustrating a positioning system arranged with an AP based on FIG. 1 according to prior art;

FIG. 3 is a schematic structural view illustrating a positioning system according to an exemplary embodiment of the present disclosure; and

FIG. 4 is a detailed structural view illustrating an auxiliary AP tag according to an exemplary embodiment of the present disclosure.

### DETAILED DESCRIPTION

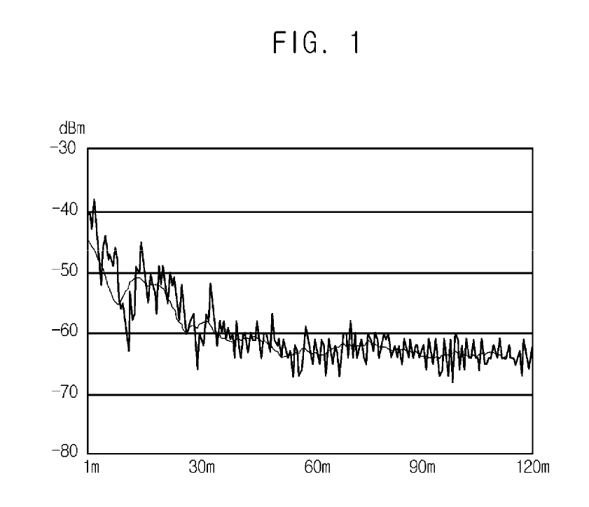

The disclosed embodiments and advantages thereof are best understood by referring to FIGS. 1-4 of the drawings, like numerals being used for like and corresponding parts of the various drawings. Other features and advantages of the disclosed embodiments will be or will become apparent to one of ordinary skill in the art upon examination of the following figures and detailed description. It is intended that all such additional features and advantages be included within the scope of the disclosed embodiments, and protected by the accompanying drawings. Further, the illustrated figures are only exemplary and not intended to assert or imply any limitation with regard to the environment, architecture, or process in which different embodiments may be implemented. Accordingly, the described aspect is intended to embrace all such alterations, modifications, and variations that fall within the scope and novel idea of the present invention.

Meanwhile, the terminology used herein is for the purpose of describing particular implementations only and is not intended to be limiting of the present disclosure. The terms “first,” “second,” and the like, herein do not denote any order, quantity, or importance, but rather are used to distinguish one element from another. For example, a second constituent element may be denoted as a first constituent element without departing from the scope and spirit of the present disclosure, and similarly, a first constituent element may be denoted as a second constituent element.

As used herein, the terms “a” and “an” herein do not denote a limitation of quantity, but rather denote the presence of at least one of the referenced item. That is, as used herein, the singular forms “a”, “an” and “the” are intended to include the plural forms as well, unless the context clearly indicates otherwise.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Also, “exemplary” is merely meant to mean an example, rather than the best. If is also to be appreciated that features, layers and/or elements depicted herein are illustrated with particular dimensions and/or orientations relative to one another for purposes of simplicity and ease of understanding, and that the actual dimensions and/or orientations may differ substantially from that illustrated.

That is, in the drawings, the size and relative sizes of layers, regions and/or other elements may be exaggerated or reduced for clarity. Like numbers refer to like elements throughout and explanations that duplicate one another will be omitted. As may be used herein, the terms “substantially” and “approximately” provide an industry-accepted tolerance for its corresponding term and/or relativity between items.

Hereinafter, an auxiliary AP (Access Point) tag and a positioning system using the same according to the present disclosure will be described in detail with reference to the accompanying drawings.

FIG. 1 is a graph illustrating a measurement of RSSI (Received Signal Strength Indicator) of a signal received by a positioning tag when a height of an AP is 1.5 m and a height of the positioning tag is 1.2 m, where a vertical axis defines an RSSI of a signal received by the positioning tag from the AP, while a horizontal axis defines a distance between the AP and the positioning tag.

Referring to FIG. 1, although a communication distance between the AP and the positioning tag is approximately 120 m, it can be noted that no more change is noticed at an initial −60 dBm, when changes in RSSI strength after 60 m are viewed. This is, in a case a position tracking is performed using the RSSI at a positioning system utilizing the WLAN, a measurement value over 60 m is a meaningless data that cannot be used for position tracking, where it can be concluded that the AP must be arranged at a 60 m interval. However, although the ‘60 m interval’ may vary depending on a height between the AP and the positioning tag, a positioning system having a position accuracy can be realized by maintaining an approximately 30 to 70 m interval.

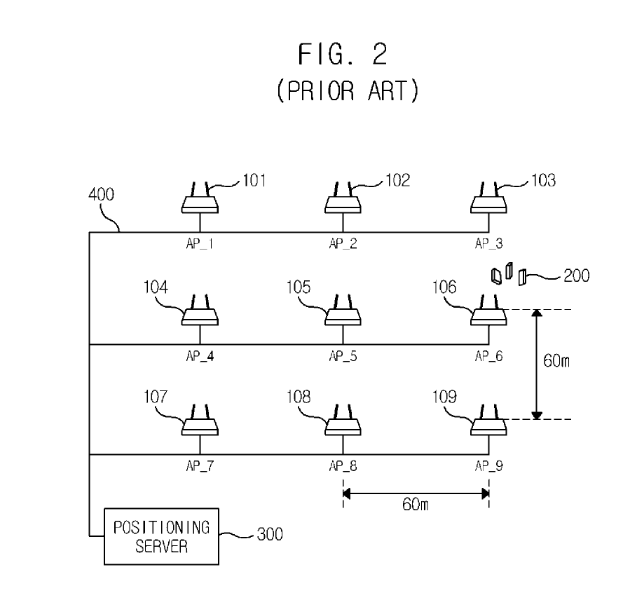

FIG. 2 is a structural view illustrating a positioning system arranged with an AP based on FIG. 1 according to prior art. Referring to FIG. 2, each AP (101 to 109) connected through wired/wireless network (400) in the conventional positioning system is arranged at a 60 m interval, and each AP (101 to 109) is connected to the through wired/wireless network (400), where a positioning tag (200) transmits its position to a positioning server (300) via the APs (101 to 109).

In the positioning system thus configured according to the prior art, although communication between the positioning tag (200) and the APs (101 to 109) can be enabled at a distance over 100 m, the AP is arranged at a 60 m interval for accuracy, disadvantageously causing a lot of cost for system build-up.

That is, there is a disadvantage in the conventional positioning system in that more APs than are needed are unnecessarily installed for the purpose of obtaining position accuracy.

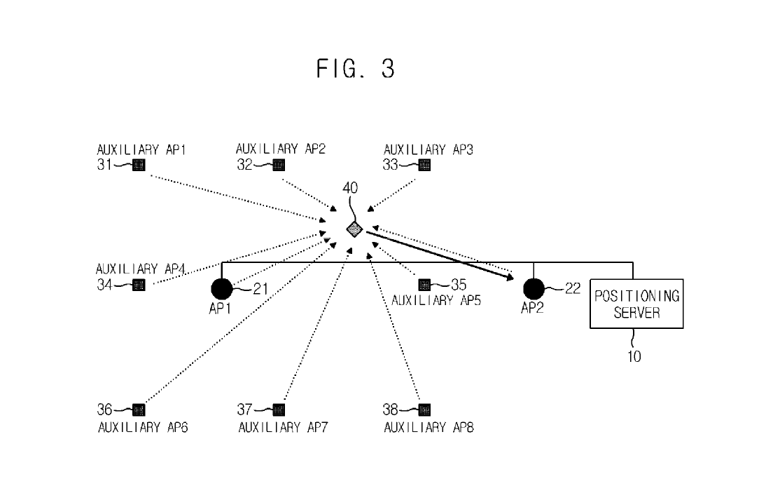

FIG. 3 is a schematic structural view illustrating a positioning system according to an exemplary embodiment of the present disclosure.

As illustrated in FIG. 3, a positioning system according to the present disclosure includes a positioning server (10), APs (21 and 22), auxiliary AP tags (31 to 38, illustrated in drawings as ‘auxiliary AP’) and a positioning tag (40).

The positioning server (10) uses a position tracking algorithm to calculate a position of the positioning tag (40). The position tracking algorithm is well known in the art such that no more detailed explanation will be provided thereto. Although FIG. 3 illustrates that the positioning server (10) and the APs (21 and 22) are connected via a wired network, it should be apparent to the skilled in the art that the positioning server (10) and the APs (21 and 22) can be connected via a wireless network.

The APs (21 and 22) serve to connect the network, and transmit information necessary for position calculation received from the positioning tag (40) via the wireless network to the positioning server (10) via wired or wireless network. The configuration of APs (21 and 22) is also well known in the art, such that no more detailed explanation will be provided thereto. It should be apparent to the skilled in the art that the number of APs is not limited to two, although FIG. 3 illustrates the number of APs to two in the explanation of the present disclosure.

The APs (21 and 22) periodically transmit identifiers respectively identifying relevant APs (21 and 22) to allow the positioning tag (40) to receive the identifiers. The auxiliary AP tags (31 to 38) have identifiers different from those of the APs (21 and 22), where a user provides the auxiliary AP tags (31 to 38) with identifiers different from those of the APs (21 and 22).

At this time, although the identifier is an SSID (Service Set Identifier), for example, but the identifier is not limited to the SSID. That is, in a case an identifier used in the system is an SSID, the auxiliary AP tags (31 to 38) are such that the SSID is provided with AP names different from the general APs (21 and 22).

The auxiliary AP tags (31 to 38) serve to periodically transmit a beacon signal including identifiers but do not perform general AP functions. That is, the auxiliary AP tags (31 to 38) do not perform the general AP functions of connecting wired network and wireless network but perform the only function of transmitting identifiers.

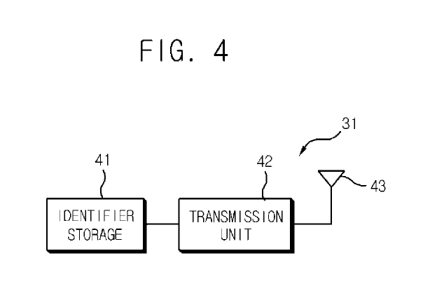

FIG. 4 is a detailed structural view illustrating an auxiliary AP tag according to an exemplary embodiment of the present disclosure, where configuration of auxiliary AP tag 1 (31) is illustrated. However, it should be apparent that configurations of other auxiliary AP tags (32 to 38) are the same as that of auxiliary AP tag 1 (31).

Referring to FIG. 4, the auxiliary AP tag 1 (31) includes an identifier storage (41), a transmission unit (42) and a transmission antenna (43).

The identifier storage (41) stores an identifier of the relevant auxiliary AP tag 1 (31), and the transmission unit (42) periodically transmits the identifier stored in the identifier storage (41) via the transmission antenna (43). A period of transmitting the identifier by the transmission unit (42) is pre-set by a user and may be changed by set-up. However, the auxiliary AP tag may include other configurations, but detailed description irrelevant to the present disclosure is omitted.

The positioning tag (40) is a movable tag, and is attached to a subject to be tracked for position. The positioning tag (40) collects an identifier of the received auxiliary AP tag (e.g., SSID) and an identifier of AP and transmits same to an AP {AP2 (22) in FIG. 3}, where the AP (22) transmits the information to the positioning server (10) via wired or wireless network, and where the positioning server (10) uses the received information to calculate a position of the positioning tag (40).

The information transmitted to the positioning server (10) includes the identifier of AP and the auxiliary AP tag received by the positioning tag (40), and strength (e.g., RSSI: Received Signal Strength Indicator) of radio wave of a signal received from the relevant AP and the auxiliary AP tag.

The positioning server (10) uses the identifiers and the strength of radio wave to calculate the position of the positioning tag (40), where the method of calculating the position may include a fingerprint method, a triangulation method, a CELL ID method and a RANDMARC method. Each method is well known in the art such that no more detailed explanation thereto will be provided.

Although transmission and reception of identifiers between the auxiliary AP tags (31 to 38) and the positioning tag (40) may not require encryption, data transmission and reception between the positioning tag (40) and the APs (21 and 22) may require encryption.

As apparent from the foregoing, the auxiliary AP tag and the positioning system using the same according to the present disclosure has an industrial applicability in that an auxiliary AP tag simpler in structure than a conventional AP is arranged at the system to be provided with only function of transmitting an identifier (e.g., SSID), whereby position accuracy can be stably obtained and cost increase can be improved.

Although the present disclosure has been described with reference to a number of illustrative embodiments thereof, it should be understood that numerous other modifications and embodiments can be devised by those skilled in the art that will fall within the spirit and scope of the principles of this disclosure.

More particularly, various variations and modifications are possible in the component parts and/or arrangements of subject combination arrangement within the scope of the disclosure, the drawings and the appended claims. In addition to variations and modifications in the component parts and/or arrangements, alternative uses will also be apparent to those skilled in the art.

What is claimed is:

1. An auxiliary AP tag of a positioning system capable of tracking a position of a positioning tag attached to a position track subject, the auxiliary AP tag comprising:
a transmission antenna;
storage storing an identifier identifying the auxiliary AP tag;
and a transmission unit transmitting the identifier through the transmission antenna.

2. The auxiliary AP tag of claim 1, wherein the identifier includes an SSID (Service Set Identifier).

2. A positioning system tracking a positioning tag attached to a position track subject, the position system comprising:
at least one or more APs transmitting information necessary for a position received from the positioning tag to a positioning server, and transmitting its identifier to the positioning tag;
a plurality of auxiliary AP tags transmitting its identifier to the positioning tag; and
the positioning server receiving information necessary for the position transmitted by the positioning tag and positioning the positioning tag.

4. The positioning system of claim 3, wherein the information necessary for positioning includes the identifier of the AP and the auxiliary AP tag received by the positioning tag and intensity of radio wave of a signal transmitted by the AP and the auxiliary AP tag.

5. The positioning system of claim 3, wherein the auxiliary AP tag transmits a beacon signal including the identifier.

6. The positioning system of claim 3, wherein the auxiliary AP tag periodically transmits the identifier at a predetermined period.

7. The positioning system of claim 3, wherein the auxiliary AP tag includes a transmission antenna, storage storing the identifier, and a transmission unit transmitting the identifier to the positioning tag through the transmission antenna.

8. The positioning system of claim 3, wherein the identifier is an SSID.
